(19) United States
(12) Patent Application Publication
(10) Pub. No.: US 2008/0143896 A1
(43) Pub. Date: Jun. 19, 2008

(54) WINDOW SHADING SYSTEM

(75) Inventor: David G. Yurth, Holladay, UT (US)

Correspondence Address: SCHWEGMAN, LUNDBERG & WOESSNER, P.A., P.O. BOX 2938, MINNEAPOLIS, MN, 55402, US

(73) Assignee: Electronically Shaded Glass, Inc.

(21) Appl. No.: 12/039,168

(22) Filed: Feb. 28, 2008

Related U.S. Application Data
(63) Continuation-in-part of application No. 10/430,877, filed on May 6, 2003, now Pat. No. 7,356,969.

(51) Int. Cl. G02F 1/1333

(52) U.S. Cl. 349/16

(57) ABSTRACT

An electronically shaded glass window shading system is described that provides a progressively darkening window, based on either user input or detection of ambient light. The electronically shaded glass window shading system may be used for commercial buildings, residential buildings, public areas, and vehicles. The electronically shaded glass window shading system may enhance energy efficiency by blocking bright light thereby reducing heat. The electronically shaded glass window shading system includes a user interface that permits a user to create opaque or alternatively transparent walls or windows as the need arises.

### RELATED APPLICATIONS

This application is a Continuation-in-Part of U.S. patent application Ser. No. 10/430,877, filed on May 6, 2003, the disclosure of which is incorporated herein by reference.

### TECHNICAL FIELD

This disclosure relates generally to shadable transparent window shading systems.

### BRIEF DESCRIPTION OF THE DRAWINGS

In order to depict the manner in which the embodiments are obtained, a more particular description of embodiments briefly described above will be rendered by reference to exemplary embodiments that are illustrated in the appended drawings. These drawings depict typical embodiments that are not necessarily drawn to scale and are not therefore to be considered to be limiting of its scope. The embodiments will be described and explained with additional specificity and detail through the use of the accompanying drawings in which:

FIG. 1 is a cross-section schematic view of a transparent laminated window shading system according to an embodiment;

FIG. 2 is a block diagram of components and interrelationships of a transparent laminated window shading system according to an embodiment;

FIG. 3 is a cross-section view of a transparent laminated window shading system according to an embodiment; and

FIG. 4 is a detail section taken from FIG. 1 according to an embodiment.

### DETAILED DESCRIPTION

This disclosure relates to window devices that use electronically controlled liquid crystal material to selectively modify the transparency of the otherwise transparent window material. More specifically, embodiments relate to window devices that use electronically controlled liquid crystal material that provides control of the transparency by application of a phase-controlled, frequency modulated current.

A window is provided with an integrated window shading system. The window has progressive shading through the use of liquid crystal display lamination material located between two panes of window glass.

A window shading system embodiment includes an integral liquid crystal material such as a thin-film technology (TFT) monochromatic dyed liquid crystal material that is positioned between two transparent panes of window glass, plastic, transparent aluminum, or the other substrates. Along with several other components, the dyed liquid crystal material provides a mechanism for progressively darkening the window shading system. In an embodiment the darkening of an entire windowpane is accomplished without the use of mechanical shades, blinds, drapes or other window coverings. The darkening of the window limits the amount of heat transmitted through the window by sunlight, provides a privacy shield, and minimizes glare.

Embodiments may be used in commercial office buildings, in residential buildings, and in public wall areas In an embodiment the window shading system is installable in automobiles, aircraft, space craft, and other vehicles where the control of the window shading system can be set to automatically darken the windows as daylight levels of sunlight increases and to lighten the windows as direct sunlight decreases through the day.

In an embodiment a user controller is provided to permit the user to set the desired amount of opacity. In an embodiment a user controller is provided to program the degree of change in opacity in response sunlight. In an embodiment a user controller is provided to rotate the plane of polarization so that circularly polarized light, also known as glare, is transmitted so as to reduce the effect of the glare.

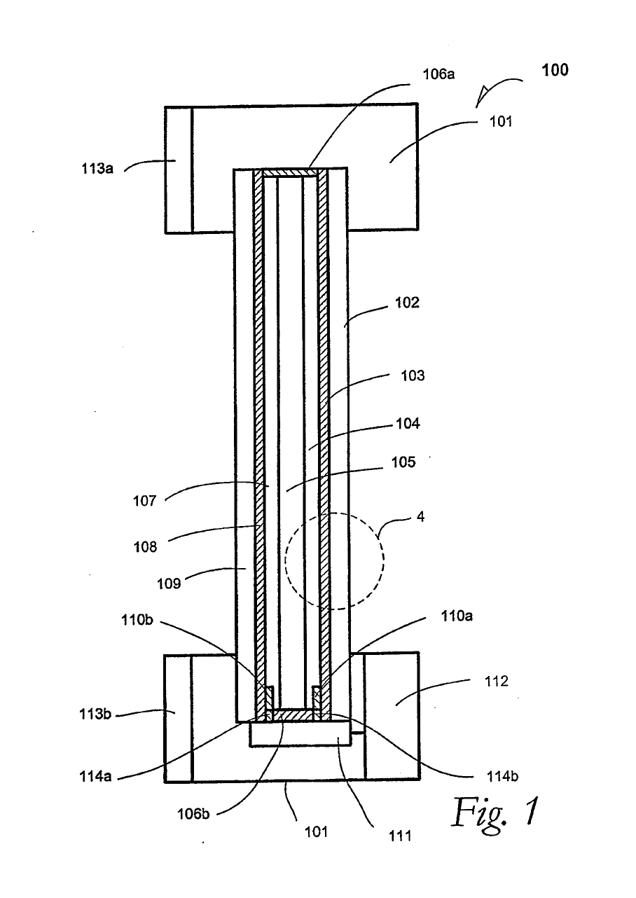

FIG. 1 is a cross-section schematic view of a transparent laminated window shading system 100 according to an embodiment. Two substrates 102 and 109, which are transparent panels 102 and 109, are held within a frame 101. In an embodiment the transparent panels 102 and 109 are composed of transparent aluminum, which is sintered corundum (α-Al₂O₃) with micro meter nano-structures on the inner surfaces thereof, such as is produced by Fraunhoffer Institute for Ceramic Technologies. In an embodiment glass may be provided for both, or at least one, of the transparent panels 102 and 109. In an embodiment polycarbonate material may be provided for both, or at least one, of the transparent panels 102 and 109. In an embodiment a transparent plastic may be provided for both, or at least one, of the transparent panels 102 and 109. In an embodiment the panels 102 and 109 may include polarizing filter qualities. In an embodiment the polarizing filter qualities may be present as surface-applied films upon the transparent panels 102 and 109. In an embodiment the panels 102 and 109 may be translucent.

According to an embodiment one surface of each transparent panel 102 and 109 is coated with a thin layer of an optically transparent electrically conductive layer 103 and 108, respectively. In an embodiment the layers of electrically conductive layer 103 and 108 is a Indium Tin Oxide (ITO). In an embodiment a different electrically conductive material 103 and 108 may be used. Each transparent panel 102 and 109 carries a transparent coating of the ITO that is etched to provide a pattern where the liquid crystal can be activated by an electric field. In an embodiment the resistance of the ITO is in the range from about 15 Ohm/sq to about 50 Ohm/sq.

A pair of gaps 104 and 107 are provided between the respective transparent panels 102 and 109 by spacers 106a and 106b. In an embodiment the gaps 104 and 107 are in a size range from about 3 nm (nanometer) to about 4 μm in width. The spacers 106a and 106b may be located in a manner, as shown here, within the frame so as to not be visible. The spacers 106a and 106b provide the a spacing between the transparent panels 102 and 109, as well as the gaps 104 and 107 between the transparent panels 102 and 109, and a liquid crystal panel 105.

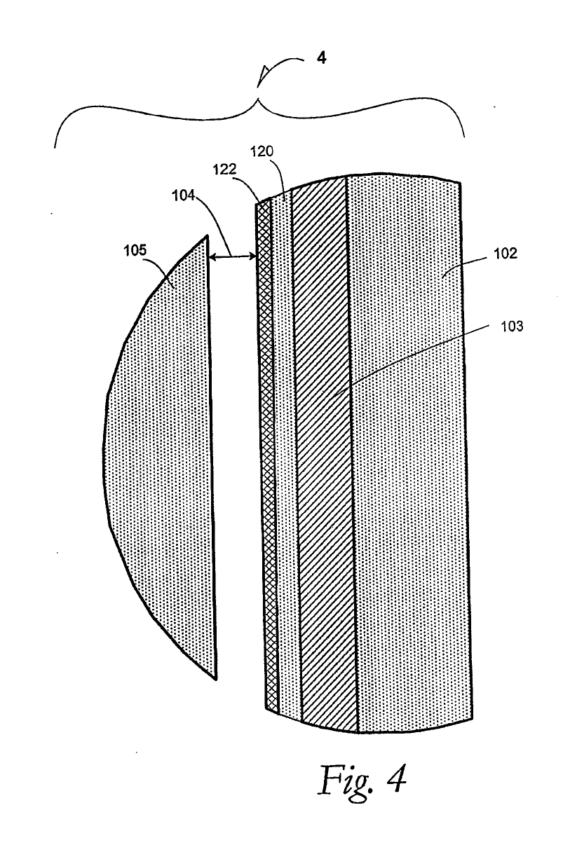

FIG. 4 is a detail section 4 taken from FIG. 1 according to an embodiment. In an embodiment where the transparent panel 102 is coated with an electrically conductive layer 103 such as the ITO, a thin (70 nm) dielectric layer 120 such as a silicon dioxide coating, the dielectric layer 120 acts as an insulation layer. On top of the dielectric layer 120 is a thin (50 nm) polymer layer 122 such as a polyimide. Such polyimides may be silica electroconductive (SE) materials that can be obtained from Nissan Chemicals such as SE-1211. The polymer layer 122 is affective to align the molecules of the liquid crystal material nematic phase in a homeotropic alignment with the long axis of the anisotropic molecules configured perpendicular to the substrate, and thus the viewing direction of the device. Accordingly, an observer may look along the optical axis of the nematic liquid crystal phase and thus light is essentially not interacted with by the liquid crystal.

Referring again to FIG. 1, the liquid crystal panel 105 contains a dyed liquid crystal. In a process embodiment the dyed liquid crystal is inserted by capillary action to fill the space defined by the spacers 106a and 106b and the transparent panels 102 and 109. In an embodiment, the dyed material is inserted into the vacuum space inside the liquid crystal panel 105. In an embodiment, the dyed material is inserted into the vacuum space inside the liquid crystal panel 105 and also between the each layer of ITO 103 and 108 such that the dyed material is contained within the space created by the spacers 106a and 106b between the transparent panels 102 and 109.

In an embodiment a black dye is used to dye the liquid crystal. In an embodiment a black dichroic (capable of exhibiting two shades) dye mixture such as from Mitsui Chemicals America, is dissolved in a chiral nematic liquid crystal of negative dielectric anisotropy. In an embodiment, the dye is about 4% S344 dye, a black dichroric dye manufactured by Mitsui Chemical America (Mitsui Toatsu Dyes), and the liquid crystal is about 20% by weight ZLI 3401 positive dielectric nematic liquid crystal, manufactured by Merck GmbH, Darmstatdt, Germany.

In an embodiment the negative dielectric anisotropy of the liquid crystal is Δ∈=<−3. The negative dielectric anisotropy liquid crystal also may have a low birefringence such as Δn=0.06. Such negative dielectric anisotropy liquid crystal materials may be obtained from Merck GmbH of Germany. Such negative dielectric anisotropy liquid crystal materials may have an operable temperature range from about negative 20° C. to about positive 75° C. The chiral liquid crystal is configured to be optically active for at least ultraviolet light. The required chirality is imparted by adding a suitable optically active material such as a compound of similar molecular structure to a liquid crystal but in which there is one or more chiral centers that impart a helical twist to the chiral nematic phase. This may create a long pitch chiral nematic phase that is suitable for the several embodiments.

In an embodiment the pitch of this chiral nematic phase is about the same width as the gap between the two transparent panels 102 and 109. Similarly, the pitch of the chiral nematic phase is about the same width created between the thin layers of electrically conductive material such as the electrically conductive material 103 and 108 embodiments.

In an embodiment the pitch of the chiral nematic phase is larger than the gap by a fraction of 0.9. In an embodiment the pitch of the chiral nematic phase is smaller than the gap. In an embodiment the pitch of the chiral nematic phase is smaller than the gap by a fraction of 0.9. In an embodiment the pitch of the chiral nematic phase is smaller than the gap by a fraction of 0.95. In an embodiment the pitch of the chiral nematic phase is smaller than the gap by a fraction of 0.97. In an embodiment the pitch of the chiral nematic phase is smaller than the gap by a fraction of 0.99. In an embodiment the pitch of the chiral nematic phase is smaller than the gap by a fraction of 0.999.

In an embodiment the dye that is used is at least one anthraquinone compound. It can be generically represented by the structure:

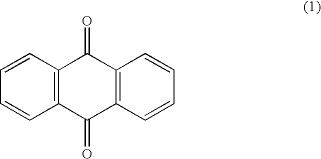

Anthraquinone is also referred to as 9,10-dioxoanthracene. Anthraquinone may be derived from anthracene. Anthraquinone may also be referred to as 9,10-anthracenedione, anthradione, 9,10-anthrachinon, anthracene-9,10-quinone, 9,10-dihydro-9,10-dioxoanthracene. It has the appearance of yellow or light gray to gray-green solid crystalline powder.

In an embodiment the dye that is used is an azo compound. It can be generically represented by the structure:

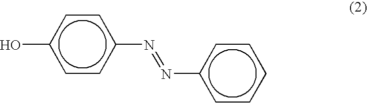

Azo compound embodiments have the functional group R—N═N—R′, in which R and R′ can be either aryl or alkyl. The N═N group is called the azo or a diimide.

In an embodiment the azo compound Sudan Black B is used. Sudan Black B has the chemical structure:

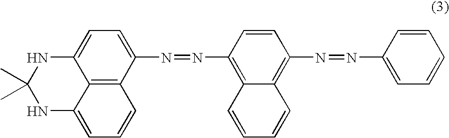

Sudan Black B (C₂₆H₂₄N₄O) is a lysochrome (fat-soluble dye) diazo dye. It has the appearance of a dark brown to black powder with maximum absorption at 596-605 nm and a melting point 120° C. to 124° C. It stains blue-black.

In an embodiment the azo compound Amidio Black is used. Amidio Black has the chemical structure:

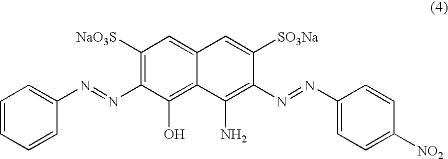

Amido black 10B, 4-Amino-5-hydroxy-3-[(4-nitrophenyl)azo]-6-1-(phenylazo)-2,7-Naphthalene disulfonic acid, disodium salt, is also called Amidoschwarz, Naphthol blue black, Acid Black 1, Acidal Black 10B, Acidal Navy Blue 3BR, Naphthalene Black 10B, Buffalo Black NBR, and C.I. 20470, is an amino acid staining diazo dye.

In an embodiment the azo compound Janus Green is used. Janus Green has the chemical structure:

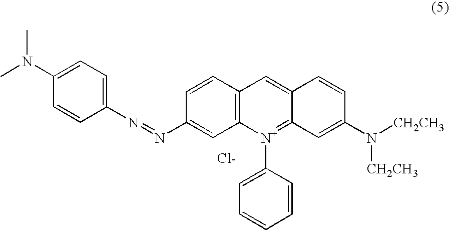

Janus Green may be represented by C₃₀H₃₁N₆Cl, or diethylsafraninazodimethylaniline chloride.

In an embodiment the dye that is used an azulene compound. It can be generically represented by the structure:

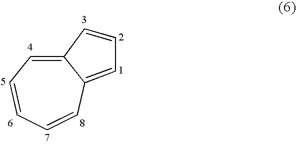

Azulene is an isomer of naphthalene and is a dark blue crystalline solid.

Other dichroric dyes may be used depending upon a specific application. Such dyes may include merocyanine compounds. Other such dyes may include tetraline compounds.

In an embodiment more than one dye may be dissolved into the liquid crystal matrix. Whereas one specific dichroric dye may be selected, a second dye may be selected to assist in achieving sufficient opacity or hue for a given application.

In an embodiment the liquid crystal matrix has been doped with at least one dye such that the liquid crystal matrix is about 5% dye. In an embodiment the liquid crystal matrix has been doped with at least one dye such that the liquid crystal matrix is about 4% dye. In an embodiment the liquid crystal matrix has been doped with at least one dye such that the liquid crystal matrix is about 3% dye. In an embodiment the liquid crystal matrix has been doped with at least one dye such that the liquid crystal matrix is about 2% dye. In an embodiment the liquid crystal matrix has been doped with at least one dye such that the liquid crystal matrix is about 1% dye. In an embodiment the liquid crystal matrix has been doped with at least one dye such that the liquid crystal matrix is about 0.5% dye. In an embodiment the liquid crystal matrix has been doped with at least one dye such that the liquid crystal matrix is about 0.1% dye.

Each substrate carries a transparent coating of indium tin oxide (ITO) that is etched to provide a pattern that is where the liquid crystal will be activated by an electric field. The resistance of the ITO is typically in the range 15-50 Ohm/sq.

Without any applied electric field, the liquid crystal is in the homeotropic state. This means the helical nature of the liquid crystal is effectively unwound by the surface effects under these cell conditions. In the homeotropic state, only the dichroic dye will have any influence on the light. Due to the dye molecules not being perfectly aligned largely due to thermal motion of the liquid crystal, some light will be absorbed by the dye. This reduces the transmission of the thin film dependant on the amount of dye used and the size of the cell gap.

In an embodiment an alternating current (AC) electric field in a range of about 6 Volt to about 10 Volt is applied across a cell gap in a range from about 4 μm to about 6 μm. The liquid crystal molecules align to reduce the interaction of the electric field and the higher dielectric constant of the molecules (which is across the short axis of the anisotropic molecules) such that the long axis of molecules gradually aligns perpendicular to the electric field, which is parallel to the substrates. This transition occurs over a few volts typically between 1.8Volt and 4.5Volt and allows a range of partial-tone levels (such as grey for a black dye) to be observed. With a black dye, the appearance of the cell gradually changes from pale grey to dark grey (black) when the electrical field is applied.

Accordingly, an embodiment provides an integrated window shading system that provides a mechanism for progressively darkening the view port defined by the window. Another embodiment provides an integrated window shading system that provides a mechanism for darkening some or all of a pane of glass through the use of liquid crystal display lamination material. An embodiment provides an integrated window shading system that can control the transfer of heat (infra-red) transmitted into an enclosure through the window by brilliant sunlight. An embodiment provides an integrated window shading system that is electronically controllable by a user. The difference in transmission between an applied electrical field and no applied electrical field is the contrast ratio and may depend upon the dye concentration, the gap sizes, the type of electrically conductive layers, and others.

In an example embodiment a 2.9% dye doping is used, and the CR is 5.7:1 with 53% light transmission. In an embodiment a 2.4% dye doping is used, and the light transmission increases but the CR is lower at 4:1. Thus the CR and transmission can be changed.

When the electrical field is removed, the liquid crystal is restored to the homeotropic alignment, likely due to surface effects, although there may be other causes. In an embodiment the restored homeotropic alignment occurs in a time range from about 60 milliseconds (ms) to about 80 ms when the field switched off abruptly. In a method embodiment the electrical field is reduced gradually, and the opacity of the window shading system diminishes proportionally.

In an embodiment the dyed liquid crystal panel 105 is formulated to allow about 90% circularly polarized light to pass through with transparency. By applying a properly modulated voltage across the dyed LCD material 105 sandwiched between the transparent panels 102 and 109, the molecules of the LCD material 105 are reoriented relative to the panes of transparent panels 102 and 109 to reduce the total light transmissivity and/or to reduce glare by altering the plane of polarization of the light which is permitted to pass through the window shading system 100. An embodiment provides an integrated window shading system that provides a controllable privacy shield. An embodiment provides an integrated window shading system that provides a mechanism for minimizing glare. An embodiment provides an integrated window shading system that provides rapid user-controllable or automatic-controlled darkening of the window in response to increases in light intensity. Another embodiment provides an integrated window shading system that reduces glare without significantly reducing transparency or light transmissivity of the window. An embodiment provides an integrated window shading system that is compatible with use in buildings and/or vehicles.

Electrical contacts (in this embodiment two contacts) 110a and 110b are connected to the electrically conductive layers 108 and 103 of the transparent panels 102 and 109. As depicted, one electrical contact 110a and 110b is connected to the respective electrically conductive layers 103 and 108. In an embodiment additional contacts may be used to couple the electrically conductive layer 103 and 108 to external circuitry. The electrical contacts 110a and 110b are connected at contacts 114a and 114b to an electrical signal source that powers a control circuit 111.

In an embodiment the control circuit 111 provides at least one of an intensity, waveform, amplitude, frequency, and phase modulated voltage signal that is specifically adapted to modulate the transparency and/or polarization of the dyed liquid crystal material. The modulated voltage signal is controlled by a modulation circuit within the control circuit 111. A power supply 112 is provided to the control circuit 111.

In an embodiment one or more photovoltaic films 113a and 113b are provided to convert ambient sunlight to electric current sufficient to power the window shading system, while the sun is shining without the need for, or to augment, batteries or externally supplied power sources.

In an embodiment the dyed liquid crystal material is connected to an electronic controller that is specifically adapted to gradually darken the dyed liquid crystal material by application of a phase-controlled and frequency modulated direct voltage current. The window shading system may provide 100% or near 100% transparency when no voltage is applied. Similarly the window shading system may darken to near complete opacity.

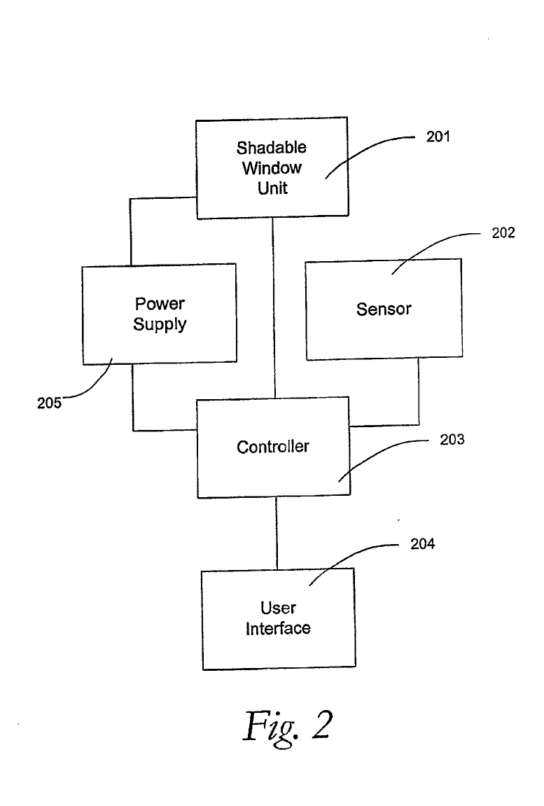

FIG. 2 is a block diagram of components and interrelationships of a transparent laminated window shading system according to an embodiment. The shadable window unit 201 receives control signals from a controller 203, which is powered by a power supply 205. A sensor 202 may be provided for detecting the amount of ambient light. A user interface 204 may be provided in communication with the controller 203. The shadable window unit 201 includes the dyed liquid crystal panel sandwiched between the transparent panels as shown in FIG. 1. The controller 203 includes a programmable microprocessor device and the modulation circuit.

The user interface 204, includes the capability to permit a user to manually darken on demand the transmissivity of the window shading system 100, as well as to program the controller 203. The user interface 204 may be electrically connected to the controller 203, or alternatively, may by a wireless remote controller.

The power supply 205 may include an AC power connection, a battery device, and/or a photovoltaic cell along with the conversion and storage circuitry required for applying power to the system. The sensor 202 may be a photo sensor suitable to detecting the luminance of the ambient light. In some embodiments, the sensor 202 may also detect brightness, intensity, and wavelength of the ambient light.

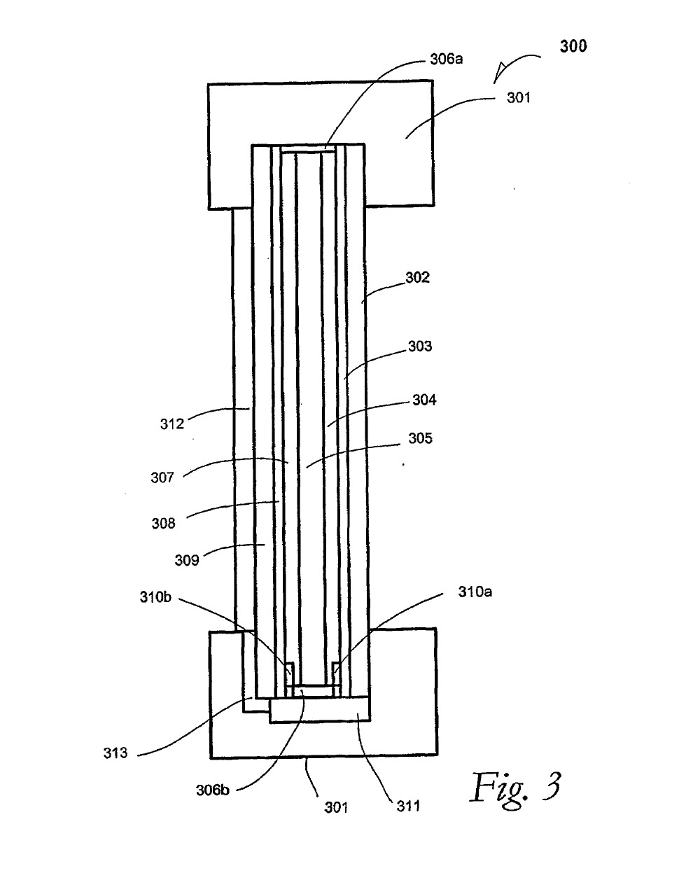

FIG. 3 is a cross-section view of a transparent laminated window shading system according to an embodiment. In this embodiment a transparent or semi-transparent photovoltaic film 312 is applied to the outer surface of the first transparent panel 309, the other surface of which has applied the conductive layer 308. The spacers 306a and 306b provide the gaps 307 and 304 between the transparent panels 309 and 302 and a dyed liquid crystal panel 305 that is sandwiched between the transparent panels 309 and 302. The second transparent panel 302 is also provided with a conductive layer 303. The photovoltaic film 312 is electrically connected 313 to the control circuit 311, which in turn is electrically connected to contacts 310a and 310b to the conductive layers 303, 308. The entire assembly 300 is held in place in frame 301.

The above-described embodiments and examples are merely illustrative of numerous and varied other embodiments and applications which may constitute applications of the principles of the several embodiments. These above-described embodiments are provided to teach the present best mode of the several embodiments only, and should not be interpreted to limit the scope of the claims. Such other embodiments may use somewhat different steps and routines which may be readily devised by those skilled in the art without departing from the scope of the several embodiments.

The Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

We claim:

1. A window shading system, comprising:
a first transparent panel including a first side and a second side;
a first electrically conductive layer attached to the second side of the first transparent panel;
a second transparent panel, having a first side and a second side;
a second electrically conductive layer attached to the second side of the second transparent panel;
a dichroric dyed liquid crystal panel held between the first electrically conductive layer and the second electrically conductive layer; and
an electrical signal source in electronic communication with the first electrically conductive layer and the second electrically conductive layer.

2. The system of claim 1 further including:
a first dielectric layer disposed on the first electrically conductive layer;
a first polymer layer disposed on the first dielectric layer;
a second dielectric layer disposed on the second electrically conductive layer, and
a second polymer layer disposed on the second dielectric layer.

3. The system of claim 1, further comprising an electronic control circuit in communication with the electrical signal source.

4. The system of claim 3, further including a power supply in electrical communication with the electronic control circuit.

5. The system of claim 1, wherein the dyed liquid crystal is dyed with at least one anthraquinone compound.

6. The system of claim 1, wherein the dyed liquid crystal is dyed with at least one azo compound.

7. The system of claim 1, wherein the dyed liquid crystal is dyed with at least one azulene compound.

8. The system of claim 1, further comprising:
a frame holding the first transparent panel and the second transparent panel in place; and
a spacer set between the first transparent panel and the second transparent panel to provide a gap.

9. The system of claim 1, wherein the first and the second transparent panels are composed of a material selected from transparent aluminum, glass, plastic, and polycarbonite.

10. The system of claim 1, wherein the first and the second electrically conductive layers are composed of indium tin oxide.

11. The system of claim 4, wherein the power supply is selected from the group consisting of: a photovoltaic cell, a battery, and an AC power source.

12. The shading system of claim 1, further including a photovoltaic film fixed to the first side of the first transparent panel.

13. An window shading system, comprising:
a shadable window unit including a dichroric dye dispersed in a liquid crystal, wherein the liquid crystal is disposed between a first electrically conductive layer and a second electrically conductive layer;
controller in electronic communication with the shadable window unit; and
a user interface in communication with the controller.

14. The window shading system of claim 11, further including:
a frame;
a first transparent panel affixed to the first electrically conductive layer on a second side thereof;
a second transparent panel affixed to the second electrically conductive layer on a second side thereof,
a first gap between the first electrically conductive layer and the liquid crystal;
a second gap between the second electrically conductive layer and the liquid crystal; and
an electrical signal source in electronic communication with the first electrically conductive layer and the second electrically conductive layer.

15. The window shading system of claim 14, wherein the controller further includes:
a modulating circuit; and
a programmable processing unit in electronic communication with the modulating circuit.

16. The window shading system of claim 15, further including a sensor for detecting light and light attributes, wherein sensor is responsive to light attributes selected from the group consisting of intensity, wavelength, brightness, luminance, and combinations thereof.

17. A method comprising responding to ambient light at a window shading system, wherein responding to the ambient light comprises:
applying a potential across a dichroric-dyed liquid crystal disposed in the window shading system, and wherein the dichroric-dyed liquid crystal reduces transparency or light transmissivity through the dichroric-dyed liquid crystal.

18. The method of claim 17, wherein the window shading system includes:
a shadable window unit including the dichroric dye dispersed in the liquid crystal, wherein the liquid crystal is disposed between a first electrically conductive layer and a second electrically conductive layer; and
a controller in electronic communication with the shadable window unit, wherein the controller is used to respond to the ambient light.

19. The method of claim 17, wherein responding to ambient light includes using a control circuit to provide at least one of an intensity, waveform, amplitude, frequency, and a phase modulated voltage signal to the dichroric-dyed liquid crystal.

20. The method of claim 17, wherein applying the potential includes applying a potential across at least one dichroric die selected from an anthraquinone compound, an azo compound, an azulene compound, a merocyanine compound, a tetraline compound, and combinations thereof.
